(19) United States
(12) Patent Application Publication
(10) Pub. No.: US 2024/0131956 A1
(43) Pub. Date: Apr. 25, 2024

(54) System and Method for Selectively Charging Batteries for Local Use Vehicles

(71) Applicant: Lion Power, LLC, Greenville, SC (US)

(72) Inventors: Michael Walker, Greenville, SC (US); John Ward, Greenville, SC (US)

(21) Appl. No.: 18/471,577

(22) Filed: Sep. 20, 2023

Related U.S. Application Data
(60) Provisional application No. 63/417,418, filed on Oct. 19, 2022.
(60) Provisional application No. 63/417,428, filed on Oct. 19, 2022.
(60) Provisional application No. 63/422,158, filed on Nov. 3, 2022.
(60) Provisional application No. 63/422,170, filed on Nov. 3, 2022.

(51) Int. Cl. B60L 53/80; B60L 53/35; B60L 53/67

(52) U.S. Cl. CPC B60L 53/80; B60L 53/35; B60L 53/67; B60L 2200/42; B60L 2260/54

(57) ABSTRACT

A system and method for selectively charging removable batteries used for powering a fleet of local use vehicles may include placing and selectively charging batteries in a charging repository. Batteries are charged to an at least threshold charge level at which the batteries may be used to power a vehicle in a duty cycle. Charging can be managed based on at least one of fleet battery replacement needs and electrical cost optimization. The repository includes at least one rack in which batteries may be charged and a robotic device for moving batteries back and forth between the rack and the vehicles. Charging batteries within the repository and supplying them to vehicles that drive to the repository for battery exchange provides efficient spatial usage.

### CROSS-REFERENCE TO RELATED APPLICATIONS

This application claims benefit to U.S. Provisional Patent Application Nos. 63/417,418 and 63/417,428, having a filing date of Oct. 19, 2022; 63/422,158 and 63/422,170, having a filing date of Nov. 3, 2022, all of which are incorporated in its entirety by reference herein.

### TECHNICAL FIELD

The present disclosure relates generally to systems and methods for selectively charging batteries for local use vehicles.

### BACKGROUND

Local use vehicles such as forklifts, golf carts, shuttles, and others are in use in many locations, such as factories, warehouses, golf courses, parks, campuses, etc. Conventionally, such vehicles were powered by a combustible fuel such as gasoline, diesel, liquid propane, compressed natural gas, etc., although use of electric (battery-powered) vehicles has become more common in recent years. Typically, to charge batteries for such electric vehicles, the user drives the vehicle to a charging location where a power cord or other connector is available to connect the vehicle's battery to a source of power. Once connected, the power source recharges the battery, usually over a period of time measured in hours (e.g., 4-8 hours for a conventional forklift, golf cart, or automobile). After charging is complete, the vehicle can be driven away for further use. If the vehicle is a robotic shuttle such as an Automatic Guided Vehicle (AGV) in a so-called Dark Warehouse or other location, the vehicle's sensors and controls work in concert with the system's sensors and controls to drive the vehicle on its working route and to and from the charging location.

Where a site owner or manager of a location has a fleet of such electric vehicles on the site, managing use and charging can be logistically problematic. Vehicles are necessarily out of service during charging. Therefore, depending on location or operational requirements, a need may exist to have systemwide down time for recharging.

For example, all vehicles may be recharged overnight, if the location is not in service overnight. Such a protocol may work for example for a golf course's golf carts which only are used during daylight hours, but not for a factory or warehouse with vehicles needed in different, longer, less-predictable, or round-the-clock hours of operation. Sometimes, “opportunity charging” can be done, wherein vehicle batteries are partially charged or topped off during shorter breaks or shift downtime, but such charging is insufficient for overall system charging needs.

Therefore, in many locations, a surplus of vehicles is obtained, beyond the number needed in a time of peak use, to account for a portion of the vehicles being recharged at any given time. For example, depending on vehicle usage, a warehouse facility could need a surplus of 30 percent or more extra vehicles to ensure sufficient vehicles are charged and ready for use. Both pausing operation and purchasing excess vehicles to account for charging can cause logistical management of vehicles, employees, and the locations in general to be more complicated, and can incur various added costs. Having one or more dedicated areas in a facility for many vehicles to sit while charging also requires a large amount of space, essentially adding a “charging parking lot” to a site design.

In some locations, discharged batteries are manually removed and replaced by workers in dedicated areas in a facility. Such locations also require extra space and manpower, and the process can be very dangerous, time consuming, and costly. Further, removing and replacing heavy batteries having precise electrical (power) and communication (data) connectors makes installation and removal to and from vehicles or charging locations complicated, as well as increasing the risk of damage to the connectors due to inattention or imprecise movement.

Accordingly, improvements would be welcome in at least one of the operation and charging of local use battery-powered vehicles, vehicle and/or battery design, charger design, control systems, charging system automation, and footprint reduction, and battery communication systems, and the like addressing one or more of the above drawbacks of existing systems, and/or providing one or more additional benefits.

### SUMMARY

According to certain aspects of the disclosure, a system is provided for selectively charging batteries within an inventory of batteries used for powering a fleet of local use vehicles, the batteries being removable from the local use vehicles for charging, the system including, for example, a charging repository housing a plurality of batteries from the inventory of batteries, the charging repository connected to an electrical power source that is selectively connectable to each of the plurality of batteries, the plurality of batteries configured for replaceable connection to the local use vehicles so as to power one of the local use vehicles during operation. A plurality of sensors is included, at least one sensor assigned to a respective one of the plurality of batteries for sensing a charge level of the respective one and for providing a signal indicative of the charge level of the respective one. A controller (e.g., a system controller) is electrically connected to the sensors for selectively determining a subgroup of the batteries within the plurality of batteries to which the electrical power source should be connected for charging to at least a charging threshold depending on the signals received from the sensors and on a fleet battery replacement need. Various options and modifications are possible.

For example, the fleet battery replacement need may be determined based on at least one of a forecast battery need, a learned battery need, a tracked battery need, and an on-demand battery need. The forecast battery need may be based on an expected rate of use of the fleet. The learned battery need may be based on a past rate of use of the fleet. The tracked battery need may be based on monitoring of use of the fleet. The on-demand battery need may be based on when the vehicles arrive at the repository for battery exchange.

In some aspects, the local use vehicles include forklifts, and the batteries are removably placeable in the local use vehicles. The batteries may include lithium-ion battery cells, and the batteries may include a housing holding the lithium-ion battery cells and a counterweight. If so, the batteries may be configured to be retrofittable so as to replace original batteries provided with the local use vehicles, and a weight of the counterweight is related to a difference in weight between a weight of the lithium-ion battery cells and a weight of the battery cells within the original batteries.

The batteries may be configured with a connector for being lifted and moved between the charging repository and the local use vehicles. The system may include a robotic device for lifting and moving the batteries, the robotic device including an end effector configured for selective attachment to the connector.

Each battery may be configured with electrical connectors configured for connection to electrical connectors in the charging repository for charging the battery and configured for connection to electrical connectors in the local use vehicles for powering the local use vehicles. The charging repository may include a rack having multiple levels, at least some of the levels including multiple charging bays, each charging bay configured for receiving and charging one of the batteries. Each charging bay may include electrical connectors connected to the electrical power source and configured for connection to electrical connectors on a battery for charging the battery. Each charging bay may also include communication connectors configured for connection to communication connectors on a battery for communication of information at least one of to the battery from the controller or to the controller from the battery. The rack may include bays dedicated to storage and monitoring of batteries without electrical connectors for charging. The charging threshold may be a charge level between a discharged state and a fully charged state high enough to permit a battery charged to the charging threshold to be power one of the vehicles in a duty cycle. A number of batteries within the subgroup of batteries may be between zero batteries and all of the subgroup of batteries.

According to other aspects of the disclosure, a method is provided for selectively charging batteries within an inventory of batteries used for powering a fleet of local use vehicles, the batteries being removable from the local use vehicles for charging, the method including, for example: housing a plurality of batteries from the inventory of batteries in a charging repository; determining a subgroup of the batteries within the plurality of batteries should be charged to at least a charging threshold depending on the signals received from the sensors and on a fleet battery replacement need; and charging the subgroup of the batteries. As above, various options and modifications are possible.

For example, the fleet battery replacement need may be determined based on at least one of a forecast battery need, a learned battery need, a tracked battery need, and an on-demand battery need. The forecast battery need may be based on an expected rate of use of the fleet. The learned battery need may be based on a past rate of use of the fleet. The tracked battery need may be based on real-time monitoring of use of the fleet. The on-demand battery need may be based on when the vehicles arrive at the repository for battery exchange.

The local use vehicles may include forklifts, and the method may include removing a battery from one of the local use vehicles and placing a battery charged to at least the charging threshold in the local use vehicle. The method may also further include the step of lifting and moving a battery between the charging repository and a local use vehicle using a robotic device.

The charging repository may include a rack having multiple levels, each of the levels including multiple charging bays, the method further including placing a battery into one of the charging bays for charging. The charging threshold may be a charge level between a discharged state and a fully charged state high enough to permit a battery charged to the charging threshold to power one of the vehicles in a duty cycle. The number of batteries within the subgroup of batteries may be between zero batteries and all of the subgroup of batteries.

### BRIEF DESCRIPTION OF THE DRAWINGS

More details of the present disclosure are set forth in the drawings.

FIG. 1 is a generalized isometric view of aspects of a system for charging batteries of a local use vehicle in a charging repository with at least one rack for holding and/or charging batteries and a robotic device for moving batteries.

FIG. 2 is an isometric view of one charging rack within the repository.

FIG. 3 is an isometric view of a robotic device contacting a battery in a local use vehicle.

FIG. 4 is an isometric view as in FIG. 3, with the robotic device holding a battery outside of the local use vehicle.

FIG. 5 is an isometric view of a battery assembly including a battery in a housing.

FIG. 6 is a view as in FIG. 5, with some outer housing walls removed.

FIG. 7 is an isometric front view of a battery removed from the housing.

FIG. 8 is an isometric rear view of the battery of FIG. 7.

FIG. 9 is a partial diagrammatic side view of the battery of FIG. 7 in contact with a cradle.

FIG. 10 is an isometric front view of the battery charging and communication assembly (cradle) that may be located in the local use vehicle or the rack.

FIG. 11 is a schematic diagram showing features and functions of one example of a battery and vehicle cradle suitable for use with the system and devices above.

FIG. 12 is a schematic diagram showing features and functions of one example of a battery and charging sleeve within a repository suitable for use with the system and devices above.

FIG. 13 is an isometric view of a robotic device for moving batteries or battery assemblies within a charging repository or between a charging repository and a local use vehicle.

### DETAILED DESCRIPTION

Detailed reference will now be made to the drawings in which examples embodying the present disclosure are shown. The detailed description uses numeral and letter designations to refer to features in the drawings. Like or similar designations in the drawings and description have been used to refer to like or similar parts of the disclosure.

The drawings and detailed description provide a full and enabling description of the disclosure and the manner and process of making and using it. Each embodiment is provided by way of explanation of the subject matter, not a limitation thereof. In fact, it will be apparent to those skilled in the art that various modifications and variations may be made to the disclosed subject matter without departing from the scope or spirit of the disclosure. For instance, features illustrated or described as part of one embodiment may be used with another embodiment to yield a still further embodiment.

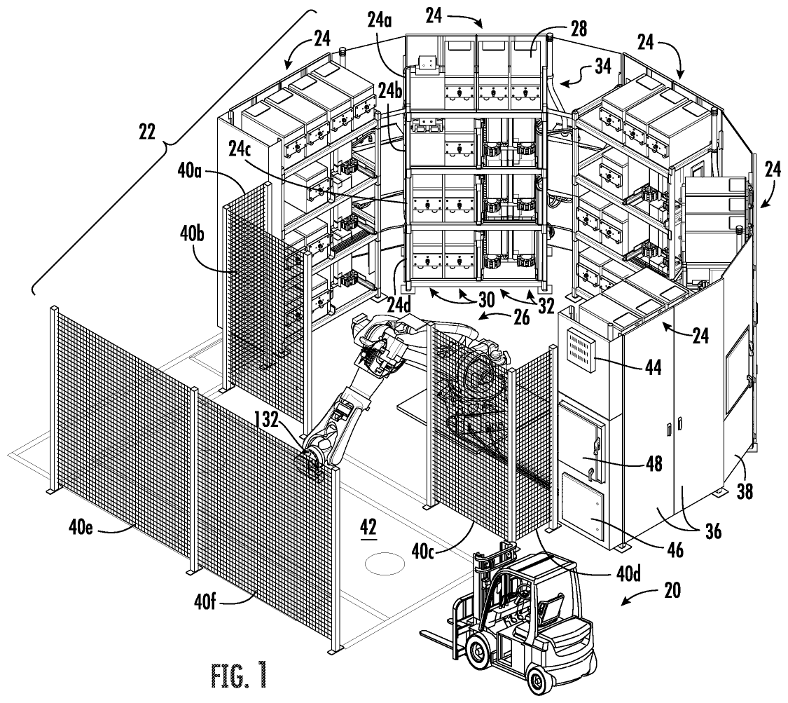

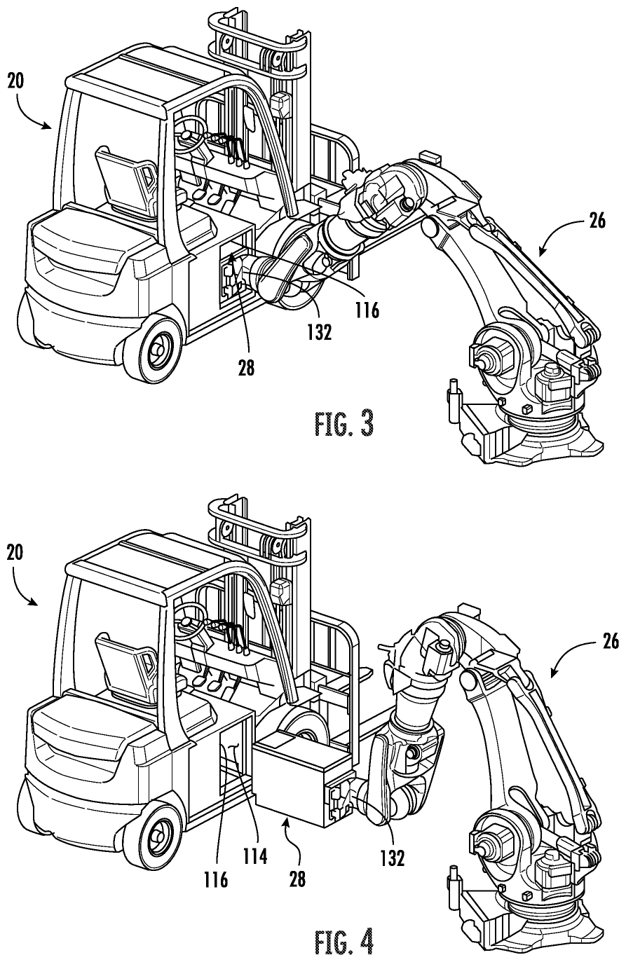

FIGS. 1-4 generally illustrate non-limiting examples of devices, systems, protocols, and methods for selectively charging batteries for a fleet of local use vehicles according to the present disclosure. The systems and methods employ charging a subgroup of batteries within an inventory of batteries, with a goal of having a sufficient number of sufficiently charged batteries (e.g., batteries charged at least to a charge threshold at which a battery has a charge level high enough to permit the battery to power one of the vehicles in a duty cycle) at the ready when need for replacement arises. Batteries are recharged in a charging repository, which may take the form of a rack, shelving unit, or the like. The repository may include several racks arranged side by side linearly or curvedly. Discharged batteries can be removed from the local use vehicles and placed in the repository for charging. Sufficiently charged batteries can be removed from the repository and inserted into the local use vehicles. Robotics can be employed to move the potentially heavy and large batteries safely and reliably between the vehicles and the repository. An articulated industrial robot, for example, with an arm, an end effector, sensors, and a programmable and/or AI logic control may be employed for such purpose. The repository may be efficiently spaced around the robot, for example in an arc allowing the robot to efficiently access batteries within the multiple bays within the repository as well as within the vehicle for exchange therebetween. The robot may also move batteries between bays within the repository, for example between a charging bay and a storage bay.

Automated systems of battery removal and installation, managing battery recharging, and providing as-needed sufficiently-charged batteries to the fleet of vehicles are thus envisioned. Batteries can be charged according to one or more control protocols, for example, wherein managing the provision of sufficiently-charged batteries and the timing and cost of electricity usage for charging. Thus, if permitted by expected or noted usage of batteries, charging can be scheduled to occur as much as possible during times of cost-optimized (“off-peak”) energy pricing. While electricity cost savings are always laudable, having a sufficient supply or a buffered supply (an amount over expected need) can be prioritized over simply optimizing charge cost.

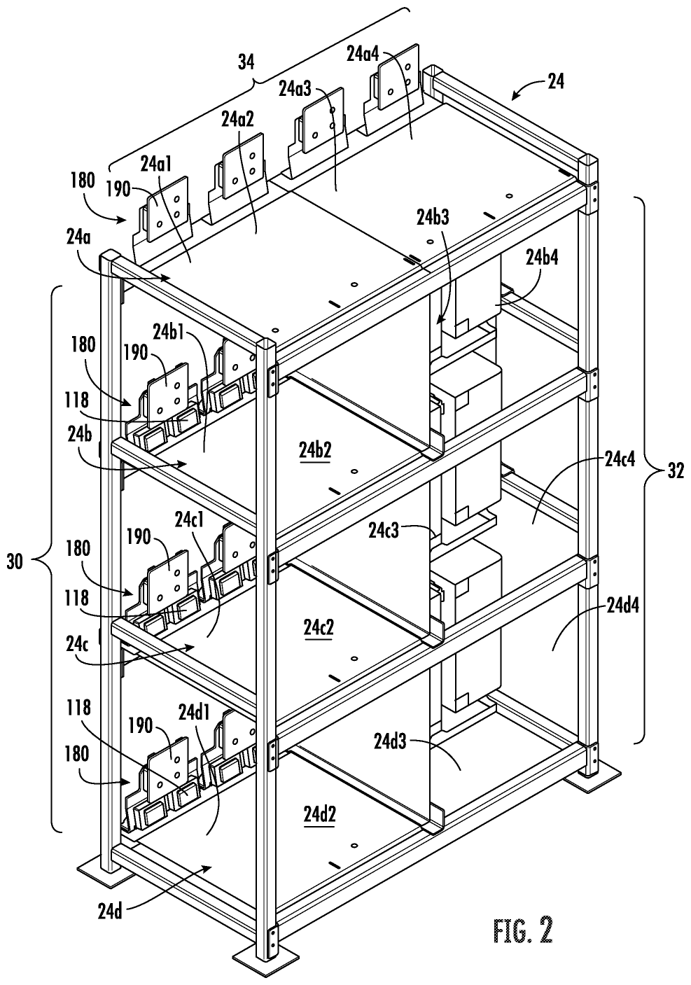

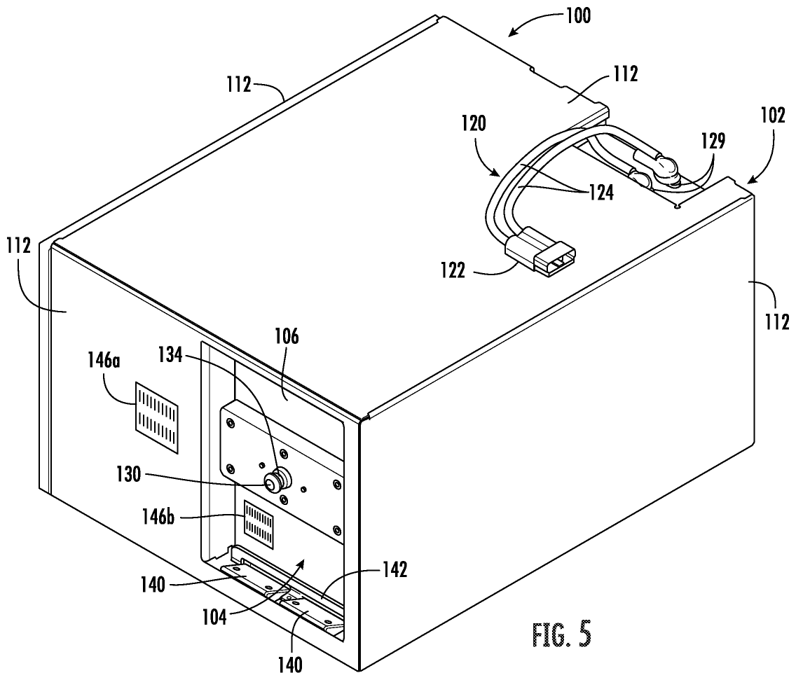

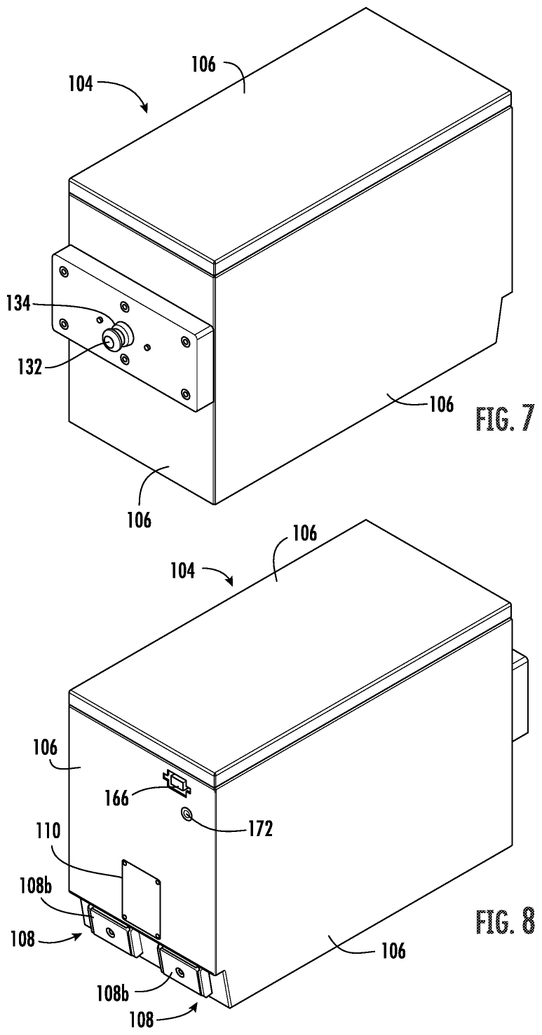

More particularly, FIGS. 1-4 depict one generalized example of a local use vehicle 20 and a charging repository 22. Repository 22 includes at least one rack 24 (see FIG. 2), with five of the racks being shown arranged in an arc in FIG. 1. Other number of racks, shapes, and arrangements are possible. More battery details and charging components are shown in FIG. 5-12.

Repository 22 also includes a robotic device 26 such as a 6-axis robotic arm. The local use vehicle 20 is one vehicle within a fleet of such vehicles (identical or differentiated) used at the depicted location in which repository is located. Batteries 28 that power local use vehicles 20 are charged and stored in repository 22. More than one repository 22 could be used at a location, whether adjacent one another or distributed throughout the location. An inventory of batteries used in the system should be enough to power all of the vehicles within the fleet plus sufficient additional batteries being charged or stored in the repository so that sufficiently charged batteries are always available when vehicles need them.

As depicted, each rack 24 includes four levels 24a-d, and each level includes four bays 24a1-24d4 that may be configured to comprise a battery charging location 30, an electricity supply and control location 32, or a battery storage location 34. As shown, top level 24a of each rack 24 is configured for storage but not charging of batteries 28. Thus, bays 24a1-4 include communicating hardware to identify and monitor batteries 28 on level 24a, but not to charge the batteries. Levels 24b-d include two battery charging locations (bays 1 and 2 on each level), and two electrical supply and control locations (bays 3 and 4 on each level). Thus, in rack 24 as shown, as many as six batteries may be charged simultaneously in levels 24b-d, and four batteries (partially or fully charged or uncharged) may be held and monitored in level 24a.

The above arrangement and uses of the bays and racks are but one example of many that could be employed.

Safety equipment and protocols may be used to protect the user or others during a battery exchange. Thus, protective devices 40a-f, such as screens, frames, rails, plastic, or glass walls, etc., may be used to define a restricted-access battery exchange location 42. The user drives a vehicle 20 into location 42 and must exit the vehicle and location to commence battery exchange. Sensors, controls, indicators, and/or safety protocols may be employed to ensure that the user has driven a vehicle to a correct spot and orientation within exchange location 42, the user has exited the vehicle and the location, and no one has reentered the location before robotic battery exchange commences and/or completes. Thus, robotic battery exchange will not be started and can be halted if such safety protocol conditions are not met.

If desired, the user may exit location 42 and may be required to operate at least one active or passive input/output device 44 connected to a system controller 46 to indicate that the vehicle is ready for battery exchange and that the user is outside of exchange location 42. The input/output device may include buttons, dials, switches, touch screens, cameras, scanners, etc., for actively indicating readiness for battery exchange or providing identifying information as to the user, vehicle, etc. Sensors may be provided (such as a weight sensitive pad on which the user stands), an optical or ultrasonic position sensor for sensing a user location in a safe space, etc., to passively indicate user presence within a desired location outside of exchange location 42 during the exchange. Additional sensors, movable screens or shields, indicators, etc. (not shown), may be provided and connected to controller 46 (within a controller cabinet) to ensure the user or another person has not reentered exchange location before completion of the battery exchange. Safety systems may be connected directly to the robot controller to prevent motion of the robot unless the operating area is safe from accidental harm.

Power may be supplied by one or more main power sources 48 (within a power source cabinet). If desired, for example, 480V AC service may be provided via a cable to power source 48, which then distributes power to the various racks and charging or storage/monitoring stations. In some embodiments, AC power may be supplied to each rack, while other embodiments may have a single connection to the system with electrical distribution contained within the system. Wired or wireless connections may also be provided for communication of data between components of repository 22 and externally.

If the vehicle is a type not driven by an operator, such as an Automatic Guided Vehicle (AGV) in a so-called Dark Warehouse or other location, the vehicle's sensors and controls work in concert with the system's sensors and controls to cause the vehicle to drive to the exchange location 42 and to indicate that the system should then exchange the vehicle battery for one from the repository.

Robotic device 26 is configured to transfer batteries 28 back-and-forth between repository 24 and vehicles 20 and may also transfer batteries within bays of the rack(s) as needed. As depicted robotic device 26 is a conventional 6-axis Kawasaki BX300L with 2800 mm of reach, however the robotic device may be any device capable of manipulating and removing the battery from a vehicle and placing it into a rack system. Robotic device 26 has an end effector configured to engage, lift, and place batteries (which may have a mass of as much as 275 kg in some cases), and the batteries have mating connectors with engagement features. The end effector may also have one or more monovision or stereo vision optical sensors, laser distancers or readers, cameras, inertial monitoring units, etc., used for reading indicia on the vehicle and/or battery for identification purposes, and/or for aligning the robotic arm with the engagement features of the battery upon approach and lifting.

As depicted, vehicle 20 is a conventional, electrically-powered forklift vehicle, although modifications related to the inventive concepts disclosed herein may be employed, as discussed below. The vehicles within the fleet may or may not be identical to each other, and the batteries within the inventory used by the vehicle(s) may or may not be identical to each other. Thus, vehicles may be forklifts, golf carts, utility vehicles, trucks, construction equipment, service vehicles, delivery vehicles, automobiles, shuttles, automated warehouse carts, etc. Many aspects of the inventive concepts herein lend themselves to use in a location having a defined inside and/or outside perimeter, such as a factory, warehouse, storage yard, logistics center, port, office park, college or school campus, outdoor parks, etc., where multiple vehicles are used to move equipment, inventory, containers, raw materials, personnel, etc., throughout the location. However, aspects of the inventive concepts herein are also applicable to vehicles that drive off-site, for example delivery trucks that travel beyond an outer perimeter of a site on which the batteries are charged. The vehicles need not be completely powered by the batteries; instead, the vehicles may be for example plug-in or other hybrid vehicles with internal combustion or other propulsion systems in addition to the batteries.

Turning to further details regarding embodiments of the batteries, their housing assemblies, and related components, FIG. 5-8 show a first embodiment of a battery assembly 100 that could be used within a system as above, for example, to power a local use vehicle, and being movable between the vehicle and a charging receptacle via by an end effector of a robotic device. However, battery assemblies described below have separate utility and accordingly, need not be used with some or all of the aspects of the above system.

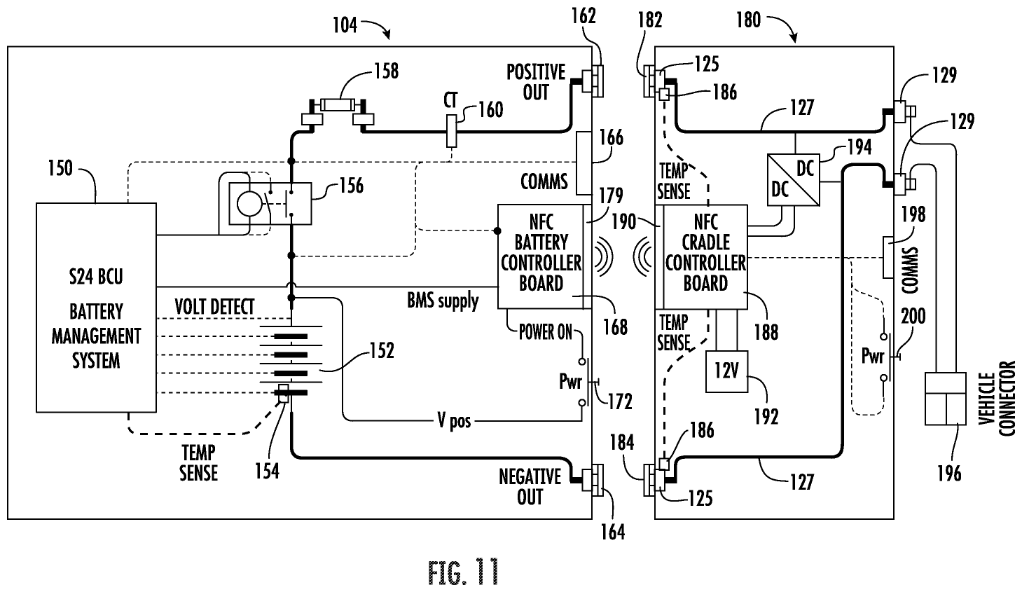

Battery assembly 100, as illustrated in FIGS. 5-8, includes a housing assembly 102 and a battery 104 within the housing assembly. Battery 104 may use lithium-ion, lithium-metal, or other battery chemistry. Battery 104 may have outer walls 106 partially or fully surrounding the battery. Battery 104 itself may include one or more connected cells (see FIG. 11) connected in parallel and/or series, as desired or needed for powering a particular vehicle in terms of desired parameters for wattage, voltage, current, charging aspects, etc., so as to provide a predetermined quantity of energy to power a local use vehicle. Other aspects of battery assembly 100 include electrical contacts 108 and a communication connection 110.

Housing assembly 102 is configured for mounting within a local use vehicle. If desired, housing assembly 102 may be sized and configured with walls, connectors, securing structure, and the like, so as to be usable to retrofit in place of an OEM lead-acid (or other) battery in a local use vehicle. Typically, the battery (cell) portion of such a lead-acid (or other) battery would have a larger form factor than that of a replacement lithium-ion or lithium metal battery. Thus, housing assembly 102 and its outer walls 112 may be configured to match the size and structural, connectional, and functional configuration of the OEM lead-acid (or other) battery. Battery 104 (including its outer walls 106) may then be located within outer walls 112 of housing assembly 102.

As discussed herein, battery 104 may be slid into and out of the vehicle (and the installed housing assembly 102) through use of a robot, as noted above, or by hand. Housing assembly 102 may thus define a battery compartment 114 within its outer walls 112, with an opening 116 through the outer walls 112 to allow such movement of battery 104. Opening 116 may remain open at all times, or may be closeable by a door, cover, etc., (not shown) if desired.

Electrical contacts and communication connections, described below, are provided between the battery and the vehicle and/or the charging repository. A substantially identical cradle/charging sleeve can be used both in the vehicles and in the racks for such electrical and communication connection.

Thus, housing assembly 102 may further include first electrical contacts 118 for contacting the electrical contacts 108 of the battery 104 when the battery is in a fully-inserted position within the battery compartment 114, and second electrical contacts 120 for electrical connection to the local use vehicle 20 for powering the local use vehicle from the battery. Electrical contacts 108, 118 may be, for example, copper plates creating a bi-directional conduction path when in contact. Electrical contacts 120 may be within a plug 122 at the end of a cable 124 for connection to the vehicle.

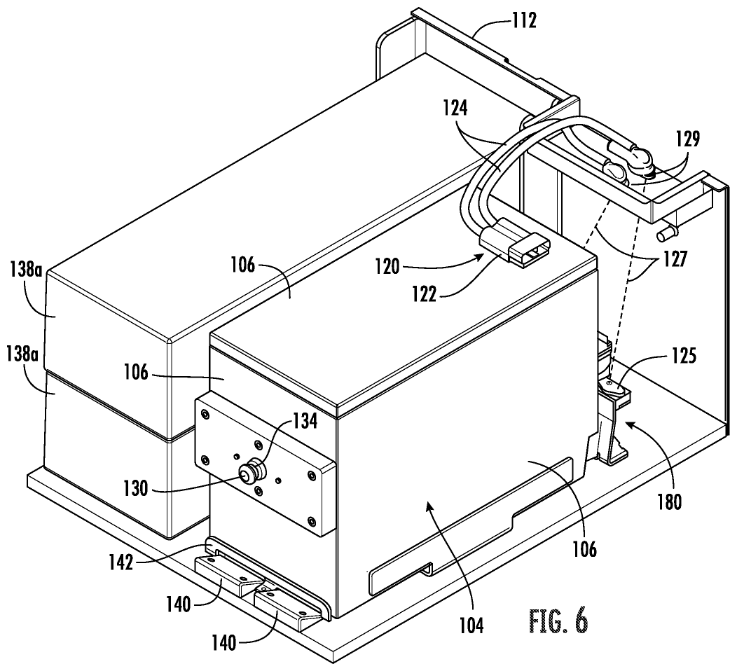

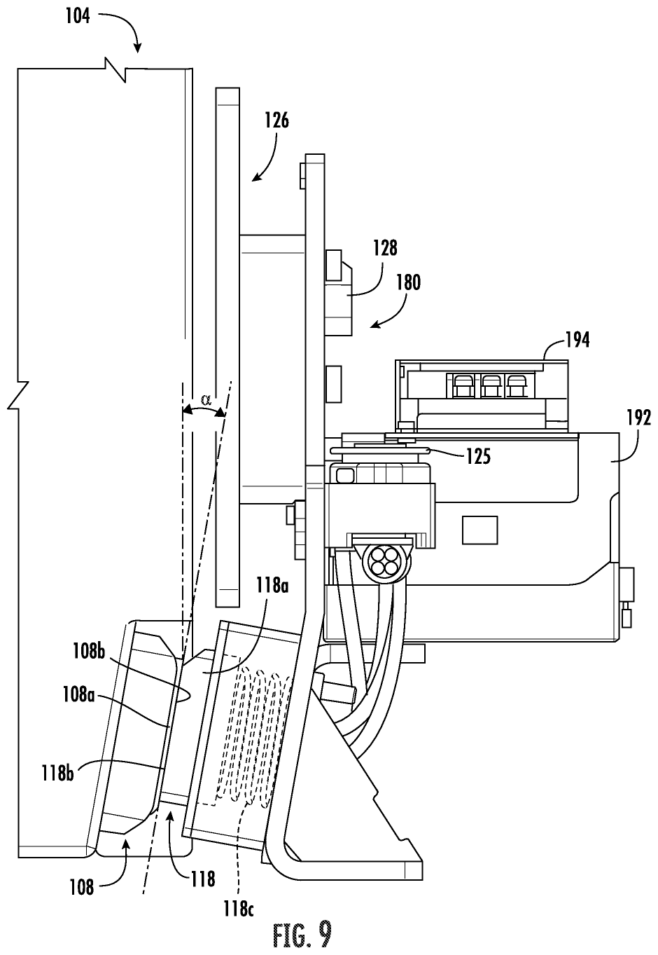

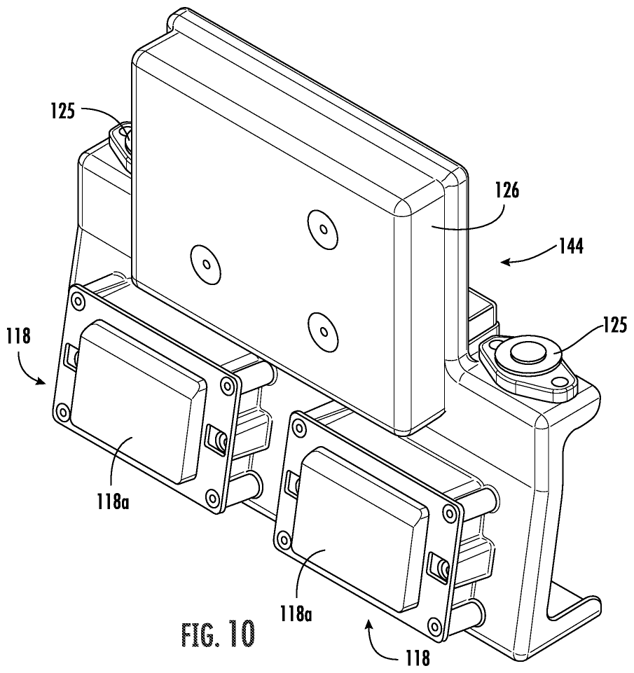

Housing assembly 102 further includes a first communication connection 126 for data communication with communication connection 110 of battery 104 when the battery is in a fully-inserted position within the battery compartment 114, and a second communication connection 128 for data communication with the local use vehicle 20. Second communication connection 128 may be a port into which a cable (not shown) is plugged. Communication connections 110,126 may be wireless and noncontact based, such as antennas for bi-directional NFC communication between the battery and housing assembly when the battery is inserted in the housing assembly. Close-proximity wireless communication provides a secure and reliable connection that does not require exact alignment and connection/disconnection steps, and avoids potential damage created thereby, when moving batteries from the vehicles to the racks and vice versa. Also, NFC communication provides benefits of avoiding frequency and bandwidth crowding where multiple batteries are being used in a location, particularly in a charging repository with many batteries. Plug 122 and cable 124 may also incorporate the wiring leading to second communication connection 128 to transmit (bi-directionally) data etc., between the battery and the vehicle using a single plug-in cable, if desired. Wires within cable 124 may be attached directly or indirectly to terminals 125 (FIGS. 9 and 10), for example, as schematically illustrated by connections 127 to exterior terminals 129 in FIGS. 5 and 6.

The battery may further include a grasping point 130 extending from one of the outer walls 106 of the battery adjacent the opening 106 in the housing assembly 102. Grasping point 106 may be of various designs, configured for complimentary use with the end effector 132 of the robotic device (see FIG. 13), with the dimensions and weight of the battery kept in mind. As illustrated, grasping point 130 is a generally cylindrical element with a groove 134 for receiving protrusions or other grasping structures in end effector 132, so that battery 104 may be grasped and moved securely by the end effector to thereby move the battery back and forth between the fully-inserted position in the housing assembly 102 (or in the vehicle directly if no housing assembly is required) and a removed position outside of the housing assembly via the opening 116 (again, in the housing assembly, or in the vehicle itself if no housing assembly is required).

If desired, electrical contacts 108 of the battery 104 and first electrical contacts of the housing assembly 118 each may have contact members 108a,118a, with contact surfaces 108b,118b for mutual contact oriented in a common plane 136 that is at an acute angle a relative to the vertical when the battery is in the fully-inserted position (see FIG. 9). Alternatively or additionally, each first electrical contact 118 of the housing assembly may include a spring member (e.g., compression spring 118c) for urging the contact member 118a in a direction toward a respective contact member 108a of battery 104. Such angled contact surfaces, and such spring-loaded contact, either separately or together, allow for a more reliable electrical connection when moving the large and massive battery using the robot than would be a vertical or horizontal contact surface without spring loading due to the wiping action provided by the relative motion during insertion. Such structures are also useful on a cradle assembly/charging sleeve on rack 24 for similar reasons. Further, if desired, the spring loading could be reversed (placed on the battery) or used on both the battery and rack.

Battery assembly 100 may, if desired, include a ballast. Such may be useful, for example, where battery assembly 100 and/or battery 104 is replacing a heavier OEM battery (such as lead acid), but may be employed in other applications as well. As shown in FIG. 6, ballast may include one or more ballast elements 138a, located within housing assembly 102 laterally adjacent battery 104. If a replacement as noted above, such ballast may have a mass related to a difference between a mass of battery 104 and housing assembly 102 and a mass of an alternate (OEM or other) energy source for powering the vehicle, the battery, the housing assembly, and the ballast being collectively configured as a retrofit of the alternate energy source. Alternatively, ballast elements may be differently located relative to the battery and housing assembly in general.

If desired, structures such as internal ribbing within housing assembly 102 or a ramp 140 adjacent opening 116 may be provided to help guide battery 104 in and out of housing assembly 102. A retaining structure may also be provided within housing assembly 102 or the vehicle to maintain battery 104 in place when inserted, so that when the vehicle moves, the battery and its contacts and connections remain in place. The retaining structure may include a fixed, movable, or removable gate 142 or other retention structure that holds battery 104 in place and in contact as desired.

Readable indicia may be located on one or more surfaces of housing assembly 102 or battery 104 (see indicia 146a, 146b) to identify any desired characteristics or positioning of the battery or housing assembly. The indicia could be words, machine readable codes such as barcodes, QR codes or the like, or positioning detection elements. As shown in FIG. 13, One or more detectors 148, such as cameras, optical or acoustic sensors, laser distancers, etc., may be mounted on robotic device 26, such as on or near end effector 132 for detecting the readable indicia or a position of the battery or vehicle. Other detectors 148 may be located on other parts of robotic device 26 or on or adjacent charging repository 22 to assist with identification and robot positioning. Some of all of the indicia may be located near the grasping point 130, if desired.

With reference to FIG. 11, and in view of previous figures, various elements and connections between the battery assembly and the vehicle or charging rack connection/cradle, will be discussed. Generally speaking, the battery assembly includes an onboard battery monitoring system and should include at least one sensor, a controller, and an auxiliary battery, although many options and customizations are possible for particular applications. Also, it should be understood that battery 104 and cradle 180 may be located within housing assembly 102 (not shown in FIG. 11 for clarity). Alternatively, cradle assembly 180 may be located within the vehicle itself—apart from any housing assembly 102 that might be provided to house battery 104, if such housing assembly is provided at all. Thus, in a simplified embodiment, a cradle could be fixed to the vehicle and the battery without an external housing such as 102 could be slid in and out of the vehicle for use/charging.

Within battery 104, the Battery Management System (BMS) controller 150 is used for battery management, and may be an S24 Bus Controller Unit (BCU). The BMS Controller may detect cell 152 voltages and may monitor temperatures via sensors 154 (one shown schematically) throughout the cell stack. Controller 150 thus tracks State of Health (SOH, i.e., estimated capacity) and State of Charge (SOC) of the cells 152, as well as monitoring current and terminal voltages.

A contactor/relay 156 may be used to open/complete the circuit of the battery cells. It is controlled by the BMS Controller 150. As a safety feature, it also can incorporate aux terminals to detect fused/welded state of the contactor, and thereby cause the controller to indicate a fault and respond as needed for the situation.

A fuse 158 may be included. If used for a forklift, it may be a conventional low-voltage, high current fuse for short circuit protection.

The battery stack 154 itself may comprise cells 152 such as high Ah capacity series/parallel array of connected battery cells providing an Ah rating of in the range of, for example, 100 Ah to 800 Ah. The cells may be prismatic or cylindrical, and the cells may have various chemistries such as Lithium Ion, Lithium NMC, LiFePO4, or other chemistries. The stack may be built in low voltage “modules” of a group of cells, with a welded, series-connection bulbar per group.

A current transducer 160, such as a Hall-effect current sensor, can be employed to detect and calculate State of Charge (SOC) or detect other conditions of the vehicle as needed by the system, which may be carried out in conjunction with the BMS Controller 150.

A positive terminal (Positive Out) 162 and a negative terminal (Negative Out) 164 are provided for electrical contact to the cradle in the vehicle or rack. Terminals 162,164 are conventional passthrough insulated/isolated terminals, and may include bolt-on copper plates for the conduction path from plate in the cradle to reduce contact resistance when connecting to the Battery Housing Terminals 182, 184.

Communication port 166 may be a plug connector for attachment to a cable and may contain for example, power/gnd, CAN communication, and a power switch signal to provide auxiliary functionality in the event the NFC battery controller 168 is not installed or unavailable. NFC battery controller board 168 controls the external communication interface to the cradle in the vehicle or rack via the NFC antenna 170, and controls onboard keep-alive power for the BMS 150. It is continuously powered by the lithium battery stack 152 terminal voltage (pre-contactor), and is able to cut its own power if necessary to limit vampire power load. It also stores data/fault codes from battery and connected devices for later upload via a telemetry system.

Power switch 172 may be a conventional contact-activated normally open switch, and may provide a “wake-up” signal for NFC board 168 to turn on active power to the BMS 150.

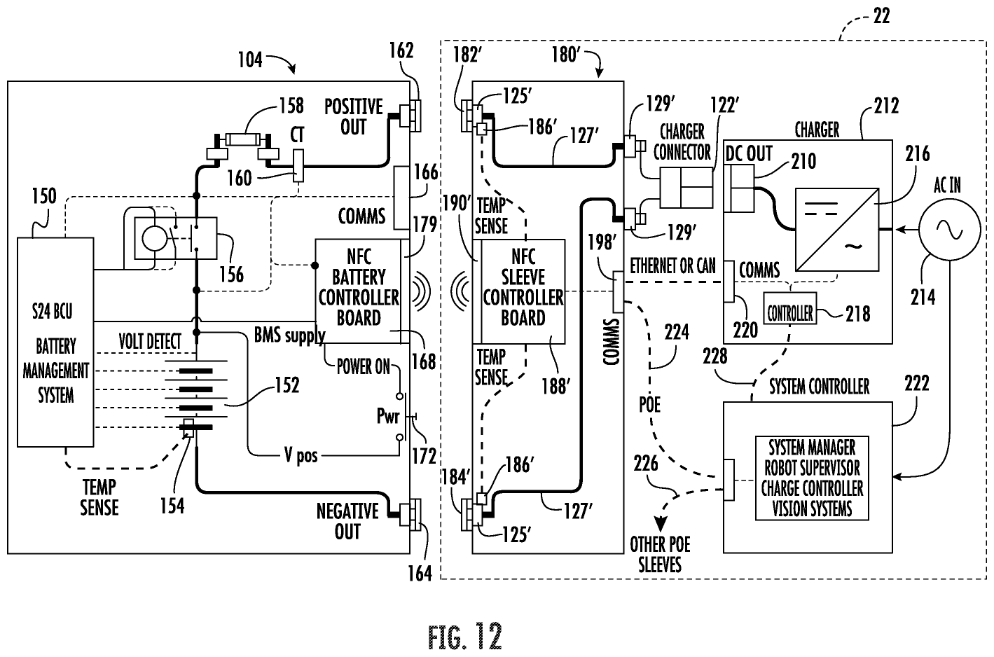

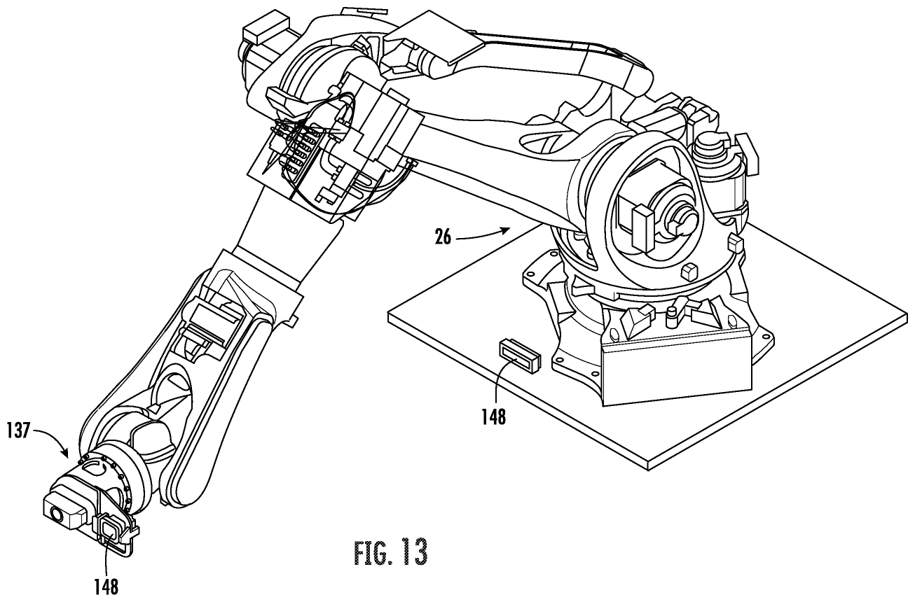

As stated above, the cradle assembly 180 shown is suitable for use in a vehicle, but a similar cradle assembly may be employed in the racks, such as charging sleeve 180′ illustrated in FIG. 12. If desired, communication functionality but not charging functionality may be provided on certain rack charging sleeves that are resident in storage locations (not charging locations), such as the top row in FIG. 2 (thus the “charging sleeves” there providing monitoring and communication function, but not charging per se. Of course, between the rack and vehicles communication and charging vs discharging would be different and in many ways reversed in the two locations. However, due to the modular and multipurpose configuration of the battery and its connectors and communication devices, many aspects of the cradles and charging sleeves may be identical in both locations.

Cradle 180 includes positive terminal 182 and negative terminal 184. Each terminal 182,184 may include spring-loaded, carbon-infused copper plates, with integrated temperature probes 186 to monitor interconnection temps using the NFC board 188 of the cradle 180. Terminals 182,184 are designed to provide a high-power connection between the battery 104 and battery housing 102 during use.

The NFC Cradle Controller Board 188 communicates with battery NFC device 168 via NFC antennas 190 and 170 to request the battery contactor be closed or opened, or may request cooling or heating of the battery based on environmental conditions. It also communicates with an attached vehicle (or rack) via CAN, serial, ethernet, or other physical electrical connection. Although called NFC antennas herein, NFC antennas 170 and/or 190 need not communicate via an NFC protocol, and may use any other suitable inductively coupled short range communications protocols.

A small back-up battery 192, such as a 12V sealed Lead Acid battery with a 5 Ah capacity, or other battery as needed, can be used to power the NFC Cradle Controller board 188, or may be used as a “keep alive” power source for maintaining external, small loads on the vehicle when main lithium battery is removed.

A DC/DC converter 194 may provide a conversion of power from lithium terminal voltage (e.g., 36V or 48V) to a lower voltage to power the NFC Cradle Controller 188 and may recharge the 12V Sealed Lead Acid battery 192.

Vehicle connector 196 may comprise plug 122 at end of cable 124 to provide connection to the vehicle at the lithium battery cell voltage (e.g., 36V, or 48V, or another voltage). It may be an Anderson SB350 connection or other, as required by the vehicle manufacturer. Additionally, the connector may be omitted if the battery housing is permanently installed in the vehicle and a more secure connection is desired.

An optional communication connector 198 is a plugin port for receiving a cable to communicate with vehicle control systems and receive requests from vehicles for power. It may also send de-rate requests to the vehicle based on battery operational requirements. If desired such communication function may be included within vehicle connector 196.

A conventional contact actuated power switch 200 may be employed to turn on the Cradle 180 if in “sleep” mode, and to enable communication and power consumption by the NFC board 188 to begin turning on the main battery. Switch 200 may be used because the battery switch may be inaccessible while the battery is installed in the Battery Housing, or the cradle may turn off to conserve power if the vehicle is not consuming energy, or for some other reason.

FIG. 12 shows a schematic presentation of battery 104 as in FIG. 11, but connected to a charging sleeve 180′ in a charging repository 22 such as one of the racks 24, discussed above, rather than a cradle 180 in a vehicle or battery housing. Common components of battery 104 in FIG. 12 are identified with common reference numerals and are not repeated below to avoid needless repetition. Cradle 180 and charging sleeve 180′ in this example include a number of similar structures and functions identified with similar reference numerals as well.

For example, charging sleeve 180′ includes positive terminal 182′ and a negative terminal 184′, in this case used for charging battery 104 while in repository 22. As above, each terminal 182′,184′ may include spring-loaded, carbon-infused copper plates, with integrated temperature probes 186′ to monitor interconnection temps using the NFC board 188′ of the charging sleeve 180′. Terminals 182′,184′ are designed to provide a high-power connection between the battery 104 during use.

The NFC Sleeve Controller Board 188′ communicates with battery NFC device 168 via NFC antennas 190′ and 170 to request the battery contactor be closed or opened, or may request cooling or heating of the battery based on environmental conditions. It also communicates with an attached through a communication port 198′ via CAN, serial, ethernet, or other physical electrical connection.

Terminals 125′ are connected via wired connections to exterior terminals 129′, for further connection to a connector 122′ vis further wiring 124′. Connector 122′ may be a plug for insertion to a DC out socket 210 of a charger assembly 212 mounted at a location in charging repository so that it can power battery 104 via charging sleeve 180′. Charger assembly 212 may be adjacent, (next to, behind, above, etc.) battery 104 one of the bays of rack 24. Charger assembly 212 receives AC power from an AC power source 214 (e.g., 20 A, 480V, 3-phase). The charger typically uses an AC/DC converter 216 to convert the AC power to DC (e.g., 24V, 36V, 48V, or 72V) for charging battery 104. Charger assembly 212 has its own onboard controller 218 that communicates with the converter 216 and external devices via its communications port 220.

A system controller 222 is provided within charging repository 22. If desired, one such controller may be provided for the entire repository (as shown), or multiple of such controllers may be provided for different portions of the repository. System controller may communicate with port 198′ (and thus charging sleeve 180′ and charger assembly 212 via connection 224. Connection 224 may be solely for data communication, or it may also provide power to charging sleeve 180′, for example via a power over ethernet (PoE) or other connection. Multiple other such connections 226 (one being illustrated for clarity) may extend from system controller 222 to other charging sleeves within repository 22. A direct (wired or wireless) data connection 228 may also be provided between system controller 222 and charger assembly 212, if desired, for control or monitoring. System controller 222 may also include wired or wireless connection other items within the system (not shown in FIG. 12), for example to control the action of the robotic device 26 via interfacing with its own controller, to receive sensor inputs regarding robot position, vehicle position, user position, battery position, and the like. The system controller can also determine expected and measured duty cycles, desired charge cycles, timing, and charge levels, and essentially manage all of the functions and features mentioned herein. Thus, system controller 222 may be a programmable logic controller, microcomputer, etc., with data inputs and outputs, and having a memory and onboard software for controlling and managing the overall system. System controller 222 may be located within one of the racks 24, or it may be in a separate cabinet or equipment rack, adjacent or remote from the racks or the system, onsite, or even remote, as desired.

Racks 24 may include dedicated non-charging storage bays that may house charging sleeves as described above (in which the charging function is simply not used). Alternatively, to reduce cost and complexity, storage location charging sleeves could be modified to delete terminals 182′184′, charger 212, and the connections therebetween, so that the communication and monitoring functions remain. Of course, storage bays need not be dedicated, and any bay within a rack with a fully functional charging sleeve could be used for battery storage (without charging), if desired.

With regard to the Near-Field Communication (NFC) technology identified in one embodiment above, it is used to establish a wireless data link between the battery and the host device when then two devices are in close proximity (i.e., in an adjacent communication orientation). It can be carried out in different formats and configurations. By using the existing logical link control protocol (LLCP) on top of the NFC wireless link, an IP-based connection may be established to allow for real-time or pseudo-real time data transfer of battery status information, which may be used to control the charging and discharging of the battery.

One benefit of such as system is that, as NFC technology only operates when two devices are in close proximity, a system of multiple batteries, chargers (i.e., using charging sleeves in multiple charging bays in a charging repository such as a rack or multiple adjacent racks), and vehicles can all operate simultaneously even when located in the same area. Use of wireless communication technologies (Bluetooth, 802.11, 5 GHz, etc.) in such crowded situation would lead to bandwidth issues, identification, issues, etc.

Each battery, charging device, and vehicle may include a controller including a microcontroller connected to an NFC ASIC and antenna. These NFC controllers are coupled the battery and its BMS with its controller, the vehicle interface controller, and the charging repository interface controller. The NFC controllers are connected to the respective device's controllers via whichever physical communication interface the device utilizes. Such connections may be, for example, serial, CAN, Ethernet, etc. The NFC controller can translate information from the device and send it over the NFC link to the charger or vehicle, and can also receive information from the charger or vehicle via the NFC link and translate to the device. By locating the NFC antenna of each charging bay/vehicle and the battery in corresponding locations relative to each other, an NFC link can be easily established when a battery is located in a charging bay or in a vehicle. Since NFC technology can only detect another antenna that is in close proximity, each battery and device can detect and initiate communication only with the desired pairings (i.e., devices in an adjacent communication orientation).

Other functions made possible by use of the NFC technology in the disclosed system and method include the ability of chargers/vehicles and batteries being able to wake the controllers from a low power sleep mode by using an interrupt function on the NFC controllers. Also, the systems can be programmed to “ferry” data from one device (to or from charger and vehicle) to another by using the battery as the intermediary carrier without relying on more expensive wireless technology for uplinks to the software repository. Thus, information such as vehicle use and performance data, fault codes, firmware information and updates, etc., may be uploaded to or from a central server when a battery is returned to the charging bay.

Thus, use of NFC technology in such systems and methods has particular applicability to locations where the replacement of rechargeable batteries in local use vehicles is a frequent occurrence, wherein a physically connected data communication link would be failure prone, and wherein the use of other wireless technologies could be problematic due to RF spectrum crowding and interference.

The disclosed subject matter is therefore particularly useful for selectively charging batteries within an inventory of batteries used for powering a fleet of local use vehicles, wherein the batteries are removable from the local use vehicles for charging. A plurality of the batteries may be housed in a charging repository while others of the batteries are located in the local use vehicle (whether used or unused). An efficient use of the batteries, vehicles, and charging system can be achieved by determining which subgroup of the batteries within the plurality of batteries should be charged to at least a charging threshold depending on the signals received from sensors within the rack monitoring the batteries there, and based on a fleet battery replacement need. By determining when and how to charge the subgroup of batteries based on such information, an efficient and effective system can be created.

The fleet battery need can be based on one or more factors, such as a forecast battery need, a learned battery need, a tracked battery need, and an on-demand battery need. The forecast battery need may be based on an expected rate of use of the fleet. The learned battery need may be based on a past rate of use of the fleet. The tracked battery need may be based on real-time monitoring of use of the fleet. The on-demand battery need may be based on when the vehicles arrive at the repository for battery exchange. Such information may be fed to the system controller which can then determine which batteries to charge and when to charge them.

While preferred embodiments of the invention have been described above, it is to be understood that any and all equivalent realizations of the present invention are included within the scope and spirit thereof. Thus, the embodiments depicted are presented by way of example only and are not intended as limitations upon the present invention. Thus, while particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

We claim:

1. A system for selectively charging batteries within an inventory of batteries used for powering a fleet of local use vehicles, the batteries being removable from the local use vehicles for charging, the system comprising:
a charging repository housing a plurality of batteries from the inventory of batteries, the charging repository connected to an electrical power source that is selectively connectable to each of the plurality of batteries, the plurality of batteries configured for replaceable connection to the local use vehicles so as to power one of the local use vehicles during operation;
a plurality of sensors, at least one sensor assigned to a respective one of the plurality of batteries for sensing a charge level of the respective one and for providing a signal indicative of the charge level of the respective one; and
a controller electrically connected to the sensors for selectively determining a subgroup of the batteries within the plurality of batteries to which the electrical power source should be connected for charging to at least a charging threshold depending on the signals received from the sensors and on a fleet battery replacement need.

2. The system of claim 1, wherein the fleet battery replacement need is determined based on at least one of a forecast battery need, a learned battery need, a tracked battery need, and an on-demand battery need.

3. The system of claim 2, wherein the forecast battery need is based on an expected rate of use of the fleet.

4. The system of claim 2, wherein the learned battery need is based on a past rate of use of the fleet.

5. The system of claim 2, wherein the tracked battery need is based on monitoring of use of the fleet.

6. The system of claim 2, wherein the on-demand battery need is based on when the vehicles arrive at the repository for battery exchange.

7. The system of claim 1, wherein the local use vehicles include forklifts.

8. The system of claim 1, wherein the batteries are removably placeable in the local use vehicles.

9. The system of claim 8, wherein the batteries include lithium-ion battery cells.

10. The system of claim 9, wherein the batteries include a housing holding the lithium-ion battery cells and a counterweight.

11. The system of claim 10, wherein the batteries are configured to be retrofittable so as to replace an energy storage system provided with the local use vehicles, and a weight of the counterweight is related to a difference in weight between a weight of the lithium-ion battery cells and a weight of components within the energy storage system.

12. The system of claim 1, wherein the batteries are configured with a connector for being lifted and moved between the charging repository and the local use vehicles.

13. The system of claim 12, the system including a robotic device for lifting and moving the batteries, the robotic device including an end effector configured for selective attachment to the connector.

14. The system of claim 1, wherein each battery is configured with electrical connectors configured for connection to electrical connectors in the charging repository for charging the battery and configured for connection to electrical connectors in the local use vehicles for powering the local use vehicles.

15. The system of claim 1, wherein the charging repository includes a rack having multiple levels, at least some of the levels including multiple charging bays, each charging bay configured for receiving and charging one of the batteries.

16. The system of claim 15, wherein each charging bay includes electrical connectors connected to the electrical power source and configured for connection to electrical connectors on a battery for charging the battery.

17. The system of claim 15, wherein each charging bay includes communication connectors configured for connection to communication connectors on a battery for communication of information at least one of to the battery from the controller or to the controller from the battery.

18. The system of claim 15, wherein the rack includes bays dedicated to storage and monitoring of batteries without electrical connectors for charging.

19. The system of claim 1, wherein the charging threshold is a charge level between a discharged state and a fully charged state high enough to permit a battery charged to the charging threshold to power one of the vehicles in a duty cycle.

20. The system of claim 1, wherein a number of batteries within the subgroup of batteries is between zero batteries and all of the subgroup of batteries.

21. A method for selectively charging batteries within an inventory of batteries used for powering a fleet of local use vehicles, the batteries being removable from the local use vehicles for charging, the method comprising:
housing a plurality of batteries from the inventory of batteries in a charging repository;
determining a subgroup of the batteries within the plurality of batteries should be charged to at least a charging threshold depending on the signals received from the sensors and on a fleet battery replacement need; and
charging the subgroup of the batteries.

22. The method of claim 21, wherein the fleet battery replacement need is determined based on at least one of a forecast battery need, a learned battery need, a tracked battery need, and an on-demand battery need.

23. The method of claim 22, wherein the forecast battery need is based on an expected rate of use of the fleet.

24. The method of claim 22, wherein the learned battery need is based on a past rate of use of the fleet.

25. The method of claim 22, wherein the tracked battery need is based on real-time monitoring of use of the fleet.

26. The method of claim 22, wherein the on-demand battery need is based on when the vehicles arrive at the repository for battery exchange.

27. The method of claim 21, wherein the local use vehicles include forklifts.

28. The method of claim 21, further including removing a battery from one of the local use vehicles and placing a battery charged to at least the charging threshold in the local use vehicle.

29. The method of claim 21, further including the step of lifting and moving a battery between the charging repository and a local use vehicle using a robotic device.

30. The method of claim 21, wherein the charging repository includes a rack having multiple levels, each of the levels including multiple charging bays, and the method further includes placing a battery into one of the charging bays for charging.

31. The method of claim 21, wherein the charging threshold is a charge level between a discharged state and a fully charged state high enough to permit a battery charged to the charging threshold to power one of the vehicles in a duty cycle.

32. The method of claim 21, wherein a number of batteries within the subgroup of batteries is between zero batteries and all of the subgroup of batteries.
